(19) United States
(12) Patent Application Publication
(10) Pub. No.: US 2023/0051722 A1
(43) Pub. Date: Feb. 16, 2023

(54) MODULAR BAR

(71) Applicant: B/E Aerospace (UK) Limited, Leighton Buzzard Bedfordshire (GB)

(72) Inventor: Peter John Leslie BURD, South Wales (GB)

(21) Appl. No.: 17/885,702

(22) Filed: Aug. 11, 2022

(30) Foreign Application Priority Data
Aug. 11, 2021 (EP) 21275110.1

(51) Int. Cl. A47B 83/02; A47C 11/00

(52) U.S. Cl. CPC A47B 83/02; A47C 11/005; B64D 11/0015

(57) ABSTRACT

A modular bar made of bar modules includes a bar element and one or more seating elements pivotably attached to the bar element. The seating element(s) is moveable relative to the bar element between a stowed position and a seat position, the module configured to be arranged adjacent one or more other bar modules to form a bar.

### CROSS-REFERENCE TO RELATED APPLICATIONS

This application claims priority to European Patent Application No. 21275110.1 filed Aug. 11, 2021, the entire contents of which is incorporated herein by reference.

### TECHNICAL FIELD

The present disclosure relates to a modular bar unit for socialising at event locations or in a vehicle such as an aircraft.

### BACKGROUND

Often there is a need to create a bar area for people to together in locations where no such bar area currently exists, for example at locations where events are organised, for gatherings at locations otherwise used for other purposes etc. In response to increasing competition for passengers and increasing passenger demands, some airlines have also started providing areas in their aircraft where people can gather to socialise or relax or sit in a bar environment away from their passenger seat, particularly on long haul flights. Such bars may be serviced or self-service and add to general passenger comfort and satisfaction. Usually, these areas on aircraft require a dedicated area of the cabin where passengers are able to stand and drink/socialise.

To install a bar at a location can be time consuming and expensive and requires a dedicated space for the bar. A bar will often have to be custom designed and built for the location in question which is cost intensive. Alternatively, a generic bar can be installed, where space permits. The bar then takes up space in a location which might, at other times, been needed for other uses.

There is a need for a more flexible bar structure that can be configured to the available space and requirements and taste for the occasion and location in question.

### SUMMARY

According to the disclosure, there is provided a bar module comprising a bar element and one or more seating elements pivotably attached to the bar element, the seating element(s) moveable relative to the bar element between a stowed position and a seat position, the module configured to be arranged adjacent one or more other bar modules to form a bar.

The seating element may be pivotably attached to the outer side of the bar element by means of a first hinge, and the seating element may comprise a frame part pivotably attached to the bar element and a seat part pivotably attached to the frame part by a second hinge.

The seating element may be a simple stool or may e.g. comprise a back rest part foldably attached to the seat part.

The outer side of the bar element may form a recessed area for the user's knees. The inner side of the bar element may be provided with a storage recess. Further, the bar element may be provided with water and/or power connections.

According to another aspect, there is provided a modular bar as defined in claim 10.

Also provided is a method of assembling a modular bar as defined in claim 15.

### BRIEF DESCRIPTION

Examples of the bar module and the modular bar according to the disclosure will now be described. The detailed description is by way of example only and variations may be possible within the scope of the claims.

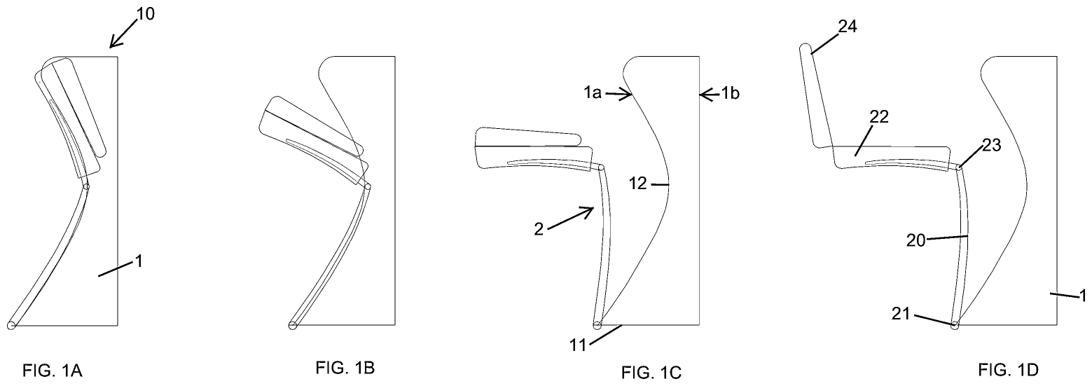

FIGS. 1A, 1B, 1C and 1D show a module according to the disclosure in different positions.

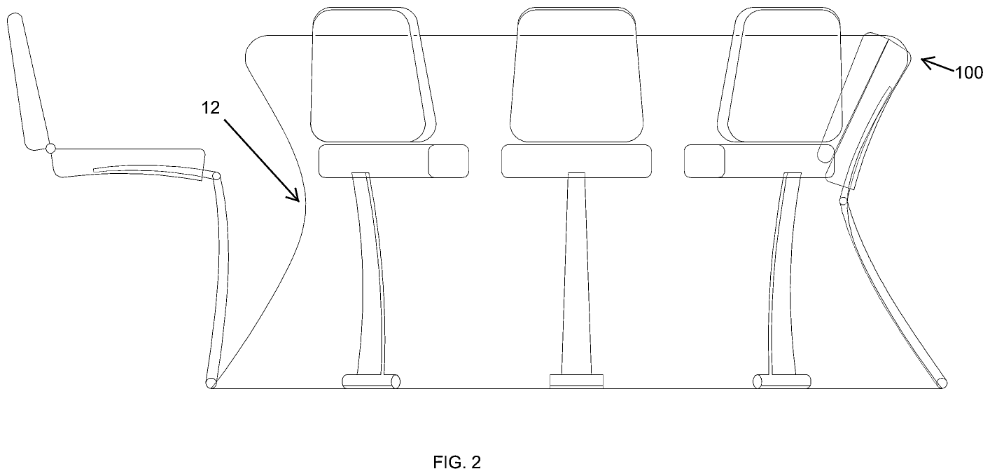

FIG. 2 shows an example of a modular bar according to the disclosure.

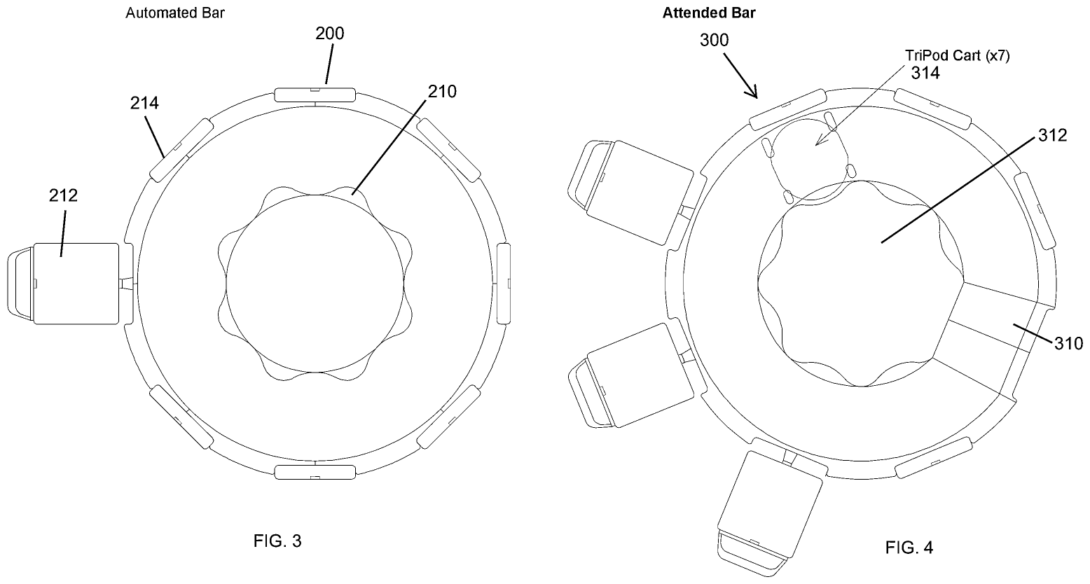

FIGS. 3 to 7 show examples of some possible configurations of a modular bar according to the disclosure.

### DETAILED DESCRIPTION

The bar module 10 according to this disclosure comprises a bar element 1 and one or more seating elements 2. The seating element 2 is foldable and pivotably attached to the bar element 1 to be pivotable and foldable between a stowed position (FIG. 1A) relative to the bar element and a seated position (FIG. 1D) as will be explained further below.

The bar module 10, here comprising a bar element 1 and one seating element 2 but may include several seat elements attached to one bar element. Several such modules can be assembled together to form a modular bar as will be described further below with reference to FIGS. 2 to 7.

In the example shown, the seating element 2 is a cantilevered structure comprising a frame part 20 attached by a first hinge 21 to the bar element 1. Other seat structures may also be envisaged. In the depicted example, the frame part is attached to a base end 11 of the bar element 1 but other attachment locations could also be envisaged. At the end of the frame part 20 opposite the end that is attached to the bar element is a seat part 22 attached to the frame part by a second hinge 23. Optionally, the seating element 2 may also include a back rest part 24 pivotally attached to the seat part 22. In the stowed position, the frame part 20 is pivoted about the first hinge 21 inwards towards an outer side 1a of the bar element 1 and the seat part 22 is either folded back against the frame part (not shown) or positioned, by means of the second hinge 23, to lie flat against the outer side 1a of the bar element 1 as shown in FIG. 1A. Where a seat back part 24 is provided, this is folded to rest on the seat part. The seat element is opened out, as required, for use as a seat as shown in FIG. 1D. In the example shown, to open the seat element out, the seat part may be pivoted about the second hinge 23 relative to the frame part 20 (FIG. 1B), the frame part 20 is then pivoted away from the bar element about the first hinge 21 (FIG. 1C) and the seat back, where provided, is folded out into an upright position (FIG. 1D). The unfolding steps could be performed in a different order. The second hinge 23 may be configured to also permit rotation of the seat part 22 such that the seat can swivel relative to the bar allowing people on adjacent seats to face each other.

Although the sides 1a, 1b of the bar element 1 may be straight, or curved or any other desired shape or surface design, in one example, the outer side 1a is provided with a concave or recessed shape 12 to provide space for a person's knees when seated on the seating element.

The individual modules can then be fitted together and combined and assembled into a modular bar according to the desired shape, size and design by placing modules side-by-side. The modules may be provided with connecting means (not shown) to allow them to be easily secured together or, alternatively, they can be merely positioned side-by-side with their side edges abutting.

FIG. 2 shows an example of a modular bar 100 in which several modules 10 as described above have been positioned together resulting in a ‘capstan’ shaped bar due to the concave knee recess 12.

The modular nature of the bar means that the modules can be assembled in a wide range of shapes and sizes to form automated/self-service or serviced/attended bars.

FIG. 3 shows one example of a circular bar 200. In the example, eight modules 10 have been combined in a circular arrangement in the middle of which may be provided a self-service counter 210. In the example shown, one seating element 212 is shown opened out into the seating position whilst the others 214 are in the stowed position. Of course, fewer or more modules can be combined into a circular arrangement.

FIG. 4 shows a circular arrangement for an attended bar 300. This is similar to the self-service bar of FIG. 3 but has an entrance 310 defined by leaving a space between two modules for bar staff to access a central service area 312 defined by the inner sides 1b of the modules. The bar elements of the modules may also be shaped to define a recess to accommodate a service cart or storage cart 314.

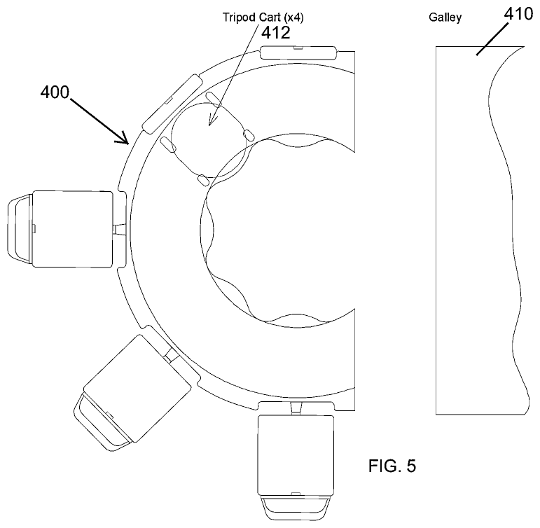

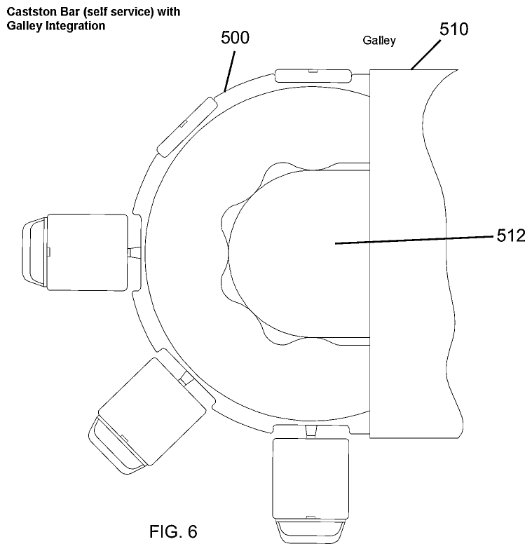

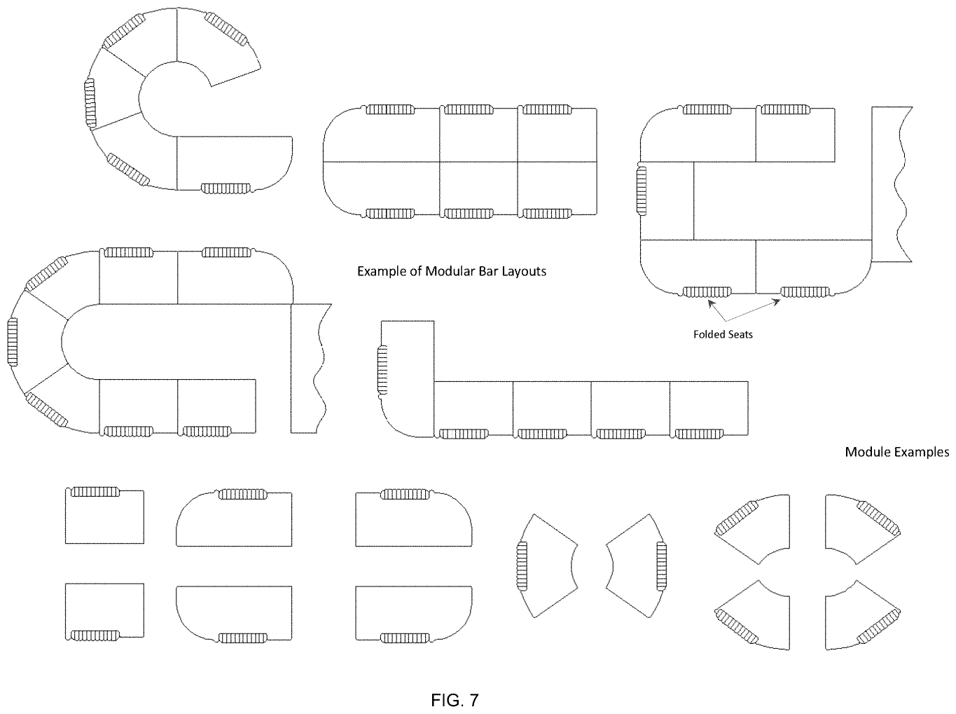

FIGS. 5 and 6 show an alternative design where the bar 400, 500 is semi-circular and can be located near a wall or, for an aircraft, a galley 410, 510. If the bar is manned, it can be spaced from the wall or galley 410 to provide access for staff to work behind the bar and carts 412 can be stowed under the bar. If the bar is a self-service bar 500, it can be located against the wall or galley 510. The inner sides 1b of the combined bar elements 1 and the galley 510 define a service area 512.

Many other shapes, configurations and sizes are possible such as those shown in FIG. 7. A number of different sized and shaped modules can be combined to form desired layouts, e.g. having a square cross-section, rectangular, polygonal, rounded.

Bar elements may also be provided with power and water connections (not shown).

Because the modules can be easily disassembled and transported and the seat elements stowed, the bar could be assembled only when needed and then folded away for storage when not needed and the layout and size of the bar can be easily adapted to different requirements and situations. In aircraft, for example, smaller or larger bars could be set up depending on the nature of the flight and service offered for each flight.

In terms of manufacturing, costs and time are reduced in that a number of standard modules can be manufactured allowing the customer to provide lighting and décor according to taste, branding etc. Different airlines, for example, could be provided with the basic modules and then provide their own branding.

1. A bar module comprising:
a bar element; and
one or more seating elements pivotably attached to the bar element, the one or more seating element moveable relative to the bar element between a stowed position and a seat position, the module configured to be arranged adjacent one or more other bar modules to form a bar.

2. The bar module of claim 1, wherein the bar element has an inner side and an outer side and wherein the one or more seating elements is pivotably attached to the outer side by means of a first hinge.

3. The bar module of claim 1, wherein the one or more seating elements comprises:
a frame part pivotably attached to the bar element; and
a seat part pivotably attached to the frame part by a second hinge.

4. The bar module of claim 3, the wherein the one ore or more seating elements further comprising a back rest part foldably attached to the seat part.

5. The bar module of claim 2, wherein the outer side of the bar element forms a recessed area.

6. The bar module of claim 5, wherein the recesses area is defined by a concave curve of the outer side.

7. The bar module of claim 2, wherein the inner side of the bar element is provided with a storage recess.

8. The bar module of claim 1, wherein the bar element is provided with attachment means for attachment to an adjacent module, in use.

9. The bar module of claim 1, wherein the bar element is provided with water or power connections.

10. A modular bar comprising:
two or more bar modules as claimed in claim 1 arranged side-by-side.

11. The modular bar as claimed in claim 10, comprising a plurality of bar modules arranged in a circle.

12. The modular bar as claimed in claim 10, comprising a plurality of bar modules arranged in a semi-circle.

13. The modular bar of claim 11 wherein the inner sides of the modules define a service area.

14. The modular bar of claim 13, wherein two adjacent modules are spaced apart to provide access to the service area.

15. A method of assembling a modular bar, comprising:
combining a plurality of bar modules as claimed in claim 1 into a modular bar layout.
